(19) United States
(12) Patent Application Publication
(10) Pub. No.: US 2011/0036644 A1
(43) Pub. Date: Feb. 17, 2011

(54) PILL COUNTER

(76) Inventor: Mahmoud Razzaghi, (US)

Correspondence Address: MAHMOUD RAZZAGHI, 865 ESPERANZA PL., CHULA VISTA, CA, 91914, US

(21) Appl. No.: 12/541,966

(22) Filed: Aug. 16, 2009

(51) Int. Cl. G01G 19/42

(52) U.S. Cl. 177/25.17

(57) ABSTRACT

The pill counter of the present invention, counts pills by measuring the weight of individual or a small number of pills as they gradually drop onto a weight scale. During the time between each pill drop, the count is obtained by comparing the weight of latest pills dropped to the expected weight ranges of one or more pills. The expected weight range includes pill weight variation and weight scale error. When the measured weight is between two expected ranges, there is at least one broken pill in addition to the whole pill count of the lower expected range. The counter adds the count of each pill drop to obtain the total count of the pills. In different approach, whenever there is a change in the reading of weight scale more than the error of the weight scale or a predetermined value, the count of pills is increased by one.

### FIELD OF THE INVENTION

This invention relates to counters for pills and any aggregate comprised of similar parts.

### BACKGROUND OF THE INVENTION

Packaging pills and filling prescriptions require counting of pills. One method to count pills is to measure the weight of the pills and divide it by the weight of a single pill. However, with the inevitable variation in the weight of each pill, error can occur in the counting. For example, if the total error in pill weights slightly exceeds the weight of one pill, the calculated count will be one more than the actual count. The level of accuracy of the weight scale also may add to the chance of error. Two or more broken pieces or other smaller pills may add up as the count of an integral pill.

In another method, pills interrupt a light beam incident on a light sensor as they drop. The number of interruptions is used as the pill count. In this method, the system may not sense a broken pill. Also, more than one pill dropping together or sticking to each other may be counted as one. There are clear pills that are transparent to the sensing light and cannot be counted. Dust from the pills eventually blocks the sensors, which further reduces reliability. Scheduled maintenance or continuous vacuum cleaning is needed for this problem. Besides, this system requires calibration for each type of pill.

In a Third method, an electrostatic signature of a pill is used to count the pills. This method can recognize broken pills but still needs calibration and has its own sensitivities which limit its accuracy.

These approaches are generally sensitive to noise such as pill dust and variations in pill shape, size, texture, weight, and transparency. Therefore, they do not provide a robust method of counting pills.

### OBJECTS OF THE INVENTION

The object of the invention is to provide a counter for pills and parts of similar shape that is not sensitive to dust, shape, texture, light transparency, or variation in the weight of the pill or part, and therefore, is more accurate.

### DESCRIPTION OF THE DRAWINGS

FIG. 1 shows the first preferred embodiment of the invention.

FIG. 2 shows the second preferred embodiment of the invention.

### BRIEF DESCRIPTION OF THE INVENTION

The pill counter of the present invention, counts pills by measuring the weight of individual or a small number of pills as they gradually drop onto a weight scale. During the time between each pill drop, the count is obtained by comparing the weight of latest pills dropped to the expected weight ranges of one or more pills. The expected weight range includes pill weight variation and scale error.

When the measured weight is below the expected range for one pill, the count is zero. When the measured weight is within the expected range for one pill, the count is one. When the measured weight is within the expected range of two pills, the count is two and so on.

When the measured weight is more than the scale measurement error but less than the expected range for one pill, there is at least one broken pill.

When the measured weight is beyond a first expected range, but less than a second immediate expected range, there is at least one broken pill in addition to the whole pill count of the first expected range.

The counter adds the count of each pill drop to obtain the total count of the pills.

The counter provides an accuracy of near 100 per cent with additional information about the count of broken pills.

The gradual stream of pills can be provided manually or by a mechanism such as a vibrating system or rotating disk.

### DETAILED DESCRIPTION OF THE INVENTION

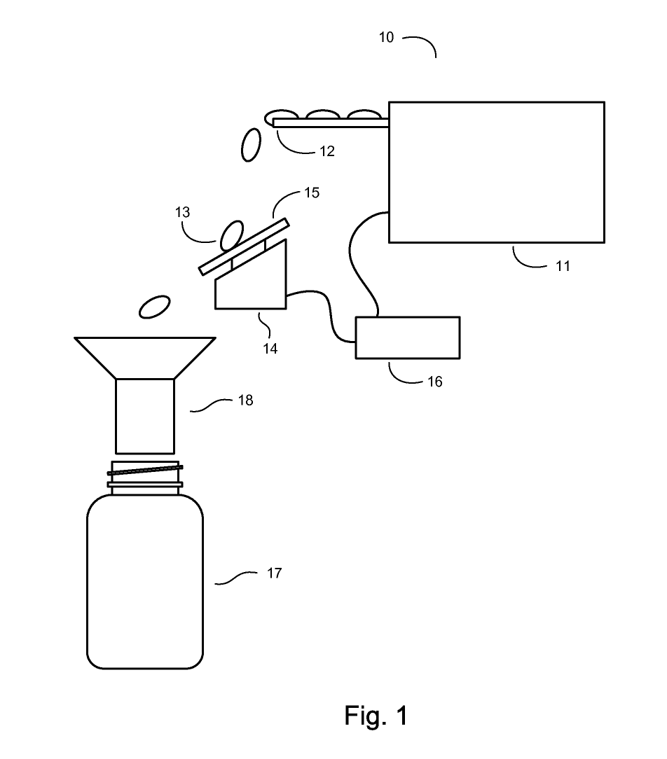

According to the first embodiment of the invention shown in FIG. 1, there is pill feeder 10 that separates pills from a bulk reservoir 11 and provides a stream of single pills flowing toward exit 12. Pill feeder 10 uses vibration or a rotating disk to separate the pills. Each separated pill such as pill 13 drops at exit 12 on weight scale 14 which has a tilted top 15. Control system 16 controls weight scale 14 and pill feeder 10. Pill 13 makes a temporary contact with the scale top 15 and drops into container 17 through collector 18.

During the time between each pill drop, control system 16 obtains the count by comparing the weight of latest pills dropped to the expected weight ranges of one or more pills. The expected weight range includes pill weight variation and scale error.

When the measured weight is below the expected range for one pill, the count is zero. When the measured weight is within the expected range for one pill, the count is one. When the measured weight is within the expected range of two pills, the count is two and so on.

When the measured weight is more than the scale measurement error but less than the expected range for one pill, there is at least one broken pill.

When the measured weight is beyond a first expected range, but less than a second immediate expected range, there is at least one broken pill in addition to the whole pill count of the first expected range.

Control system 16 adds the count of each pill drop to obtain the total count of the pills. Control system 16 reduces the speed of feeder 10 when the count gets close to a set value and stops it when the count reaches the set value.

The counter provides an accuracy of near 100 per cent with additional information about the count of broken pills.

Although the pills should generally drop one at a time, if two or more pills stick together or drop nearly simultaneously, the pill counter still provides the correct count.

As an example, consider counting 200 mg pills with a weight variation range of ±10 mg with a scale error of ±2 mg. The expected weight range would be 188 mg to 212 mg for one pill and 376 mg to 424 mg for two pills. If the scale reads 195 mg the count is 1. If the scale reads 403 mg, the count is 2. If the scale reads 179 mg, the count is zero but with a broken pill. If the scale reads 271 mg, the count is 1 but with an additional broken pill.

The drop distance from exit 12 to weight scale 14 can be reduced to minimize the effect of pill drop impact on the measured weight. Also, the equivalent weight of the pill impact may be included in expected weight ranges of the pill. In another approach, control system 16 ignores the initial impact and measures the dead or static weight of the pill. This can be done simply by waiting for a predetermined time after the pill impact and before registering the weight of the pill.

The stream of pills may also be provided manually for applications such as retail pharmacy.

An important advantage and principle of this invention is counting pills by measuring the weight of each individual pill, or a relatively small number of pills, and comparing that weight to the nominal or expected weight range of the pill. This provides a counting system that is robust or insensitive to pill weight variation, dust and other noise. The pill counter also recognizes the count of simultaneous drop of more than one pill, stuck pills and broken pills. As a result, it provides counting accuracies beyond those of other available technologies.

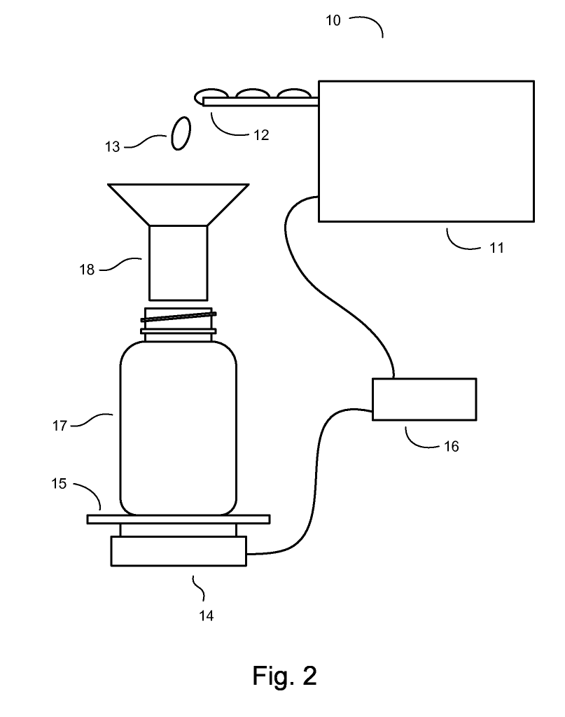

In the second preferred embodiment of the invention shown in FIG. 2, there is pill feeder 10 that separates pills from a bulk reservoir 11 and provides a stream of single pills flowing toward exit 12. Pill feeder 10 uses vibration or a rotating disk to separate the pills. Each separated pill such as pill 13 drops at exit 12 into container 17 on weight scale 14 which has a horizontal platform 15. Control system 16 controls weight scale 14 and pill feeder 10.

At the start of the operation, control system 16 resets scale 14 to zero. As each pill drops into the bottle, weight scale 14 measures its weight. During the time between each pill drop, control system 16 obtains the count as in the first preferred embodiment.

Control system 16 adds the count of each pill drop to obtain the total count of the pills and then resets weight scale 14 again to weigh the next pills. Instead of resetting weight scale 14, control system 16 may keep the latest reading and subtract it from the next weight reading to find the weight of next pills.

Control system 16 reduces the speed of feeder 10 when the count gets close to a set value and stops it when the count reaches the set value.

The gradual stream of pills is provided manually or by a separating mechanism such as a vibrating system or rotating disk.

All general properties and features explained in the first preferred embodiment also apply to the second preferred embodiment.

Both embodiments can use another method of counting. Any change in the weight sensed by the weight scale beyond its normal error or a predetermined value is considered as addition of another pill. When weight scale error is used, any pill can be counted without the need to know its weight, but broken pills will be counted as whole pills. With a predetermined value equal to the lowest acceptable weight of a specific pill, broken pills will be ignored in the counting.

Although the descriptions are explained for a pill counting application, the principle of the invention is applicable to counting of other items too.

I claim:

1. A pill counter comprised of:
a weight scale to temporarily receive and measure the weight of pills from a stream of separated pills,
a control system to compare the measured pill weight to the expected weight ranges of one or more pills, find the count of whole and possible broken pills and add each to the sum of previous respective counts,
the expected weight ranges of pills include variation in pill weight and weight scale measurement error,
when the measured weight is below the expected range for one pill, the count is zero,
when the measured weight is within the expected range for one pill, the count is one,
when the measured weight is within the expected range of two pills, the count is two and so on,
when the measured weight is more than the weight scale measurement error but less than the expected range for one pill there is at least one broken pill,
when the measured weight is beyond a first expected range, but less than a second immediate expected range, there is at least one broken pill in addition to the whole pill count of the first expected range.

2. The pill counter of claim 1 wherein the weight scale has a sloped or curved platform for temporary support of the pills during weighing and counting, the pills drop off the platform due to their weight or motion.

3. The pill counter of claim 1 wherein a container such as a pill bottle receives the counted pills.

4. The pill counter of claim 1 wherein the control system eliminates the effect of pill impact on the measured pill weight due to the pill dropping onto the weight scale.

5. The pill counter of claim 4 wherein the control system waits for the effect of impact to diminish before registering the dead weight of the pill.

6. A pill counter comprised of:
a weight scale to receive and measure the weight of pills from a stream of dropping separated pills,
a control system to reset the weight scale to zero at the start of counting, obtain the measured weight of pills in each pill drop, compare the measured pill weight to the expected weight ranges of one or more pills, find the count of whole and possible broken pills and add each to the sum of previous respective counts,
when the measured weight is below the expected range for one pill, the count is zero,
when the measured weight is within the expected range for one pill, the count is one,
When the measured weight is within the expected range of two pills, the count is two and so on,
when the measured weight is more than the weight scale measurement error but less than the expected range for one pill there is at least one broken pill,
when the measured weight is beyond a first expected range, but less than a second immediate expected range, there is at least one broken pill in addition to the whole pill count of the first expected range.

7. The pill counter of claim 6 wherein the control system resets the weight scale to measure the weight for next pills received.

8. The pill counter of claim 6 wherein the control system subtracts the measured weights between two pill drops to measure the weight for next pills received.

9. The pill counter of claim 6 wherein a container such as a pill bottle rests on the weight scale to receive the pills.

10. The pill counter of claim 6 wherein the control system eliminates the effect of pill impact on the measured pill weight due to the pill dropping onto the weight scale.

11. The pill counter of claim 8 wherein the control system waits for the effect of impact to diminish before registering the dead weight of the pill.

12. A pill counter comprised of:
a weight scale to receive and measure the weight of pills from a stream of dropping separated pills,
a control system to add one to the count of pills whenever there is a change in the reading of weight scale more than the error of the weight scale or a predetermined value.

13. The pill counter of claim 13 wherein the predetermined value is the lowest acceptable weight of a pill.

14. The pill counter of claim 12 wherein a container such as a pill bottle rests on the weight scale to receive the pills.
